(19) United States
(12) Patent Application Publication
(10) Pub. No.: US 2010/0146457 A1
(43) Pub. Date: Jun. 10, 2010

(54) Interactive Display

(76) Inventors: Harold Thimbleby, Swansea (GB); Will Thimbleby, Swansea (GB)

Correspondence Address: WADDEY & PATTERSON, P.C., 1600 DIVISION STREET, SUITE 500, NASHVILLE, TN, 37203, US

(21) Appl. No.: 11/993,417

(22) PCT Filed: Jun. 23, 2006
(86) PCT No.: PCT/GB2006/002321

§ 371 Date: Jan. 26, 2010

(30) Foreign Application Priority Data
Jun. 24, 2005 (GB) 0512865.7

(51) Int. Cl. G06F 3/033

(52) U.S. Cl. 715/863

(57) ABSTRACT

A pen-based calculator, wherein the user is presented with a screen and a gesture based input device by means of which a sum can be “handwritten” and displayed on the screen. The visibility on the screen of the system's status is provided through two types of feedback: annotation and morphing. As the user is writing the expression, the system can process in the background and, as a symbol is recognised, the user is made aware of this recognition by visual feedback: a typeset character stretched to the stroke's hull replaces the written strokes. Morphing formats the entered expression into a correctly typeset equation by moving the symbols as little as possible from the user's writing, and the morph provides the continuity between the user's input and the typeset equation that allows them to continue to edit and use it. Finally, the answer may be displayed at the correct location relative to the equation.

This invention relates generally to an interactive display device and, more particularly but not necessarily exclusively, to an interactive calculator for gesture-based user interfaces, such as interactive white boards, finger- or pen-based devices, and the like.

Known hand-held calculators make change hard. Often as a result of having very simple user interfaces, many of them lack any ability to change—requiring a complete restart of the user's actions and a loss of all intermediate work. On simple calculators, the number being entered can be restarted (pressing ‘CE’ or similar); on more advanced calculators, the entered sum can be changed one character at a time, as in a simple word processor.

Premature commitment is a problem that standard calculators exhibit: rarely, if ever, is the user allowed to undo or alter what they have calculated. Furthermore, most calculators show their workings only to the extent of the last numeric value squeezed into their display; advanced calculators may show the for instance numeric value plus the last formula entered by the user. Many calculators are ‘non-mathematical’ and for example take 2+3×2 to be 10, not 8; advanced calculators might be called ‘algebraic’ but still have problems (typically dealing with negative numbers, exponents, complex numbers, and so on in inconsistent ways), which create much more sophisticated and harder problems for the user to notice or handle.

Error-proneness is a problem for any calculator. Users use calculators to do things they could not do without them, and errors arising in use are rarely, if ever noticed, whether they are caused by the user or by design. Current calculators exacerbate this problem by failing to provide a visible history or even adequate error messages.

It is therefore an object of the present invention to provide a gesture-based user interface in which the above-mentioned problems are alleviated by the provision of intuitive modification of a displayed expression as a result of dynamic manual modification of elements thereof.

In accordance with the present invention, there is provided a gesture-based user interface, comprising display means and a gesture-based input means for generating a user-defined expression comprised of characters, digits and/or symbols for display on said display means, the user interface further comprising recognition means for recognising said characters, digits and/or symbols, means for enabling a user-defined edit event in respect of a portion of said expression, an edit event comprising adding, moving, deleting or altering one or more characters, digits or symbols, means for recognising said edit event and automatically rearranging said expression to maintain the syntax thereof depending on the nature of an edit event and the relationship between the revised set of characters, digits and/or symbols resulting from said edit event.

Thus, the present invention provides a substantially instantly declarative (this new term is defined below) interface, e.g., a calculator, which employs a concept known hereinafter as “ink editing,” whereby a user can add, delete or move a body of “ink” in respect of the displayed expression and the interface is arranged to rearrange the expression to take into account the edit event, whilst maintaining the correct syntax and, in general, semantics of the expression.

In a preferred embodiment, the recognition means is arranged to re-render said characters, digits and/or symbols to a typeset format for display on said display means. Preferably, in the case where the interface comprises a calculator and the expression comprises a mathematical equation having one or more unknown quantities, the interface may be arranged to automatically calculate said unknown quantity wherever it is (or they are). The resultant unknown quantities may be displayed on the display means as an integral part of the displayed equation, or it may be hidden (to allow a user to attempt to insert the correct quantity, for instance for educational or play purposes).

In a preferred embodiment, the interface may be arranged and configured to automatically correct one or more user-defined elements of an expression, in the event that the expression is syntactically incorrect, and display the resultant syntactically correct expression on the display means. Beneficially, user-defined elements of an expression are displayed in, for example, a different format or colour relative to elements defined or calculated by the interface.

Means may be provided to define and drag portions of a displayed expression, either to another location within the expression, or to a location on said display means defining a wastebasket for discarding the defined portion of the expression. This is usually called drag and drop, but is used here closely tied with the gestures of ringing and dragging, with time delays and context to disambiguate the meaning thus: if a gesture is drawn around more than one symbol, it is immediately taken to be a selection; if a gesture is drawn near or between existing symbols it might be a new symbol or a selection—a delay is added, so if the user pauses, it is taken as a selection, if they stop, it is then processed to be recognised as a new symbol.

Once a selection is recognised as such, the user may extend or modify it by continued gestures, typically to include further parts of the ink.

Deletion can be achieved either by drag and drop to a wastebasket or similar icon (as described above), or symbols can be crossed out, using a special gesture, such as ∠ or an erasing-like-scribble (such as ξ) written over the symbols to be deleted. Beneficially, all deletion, whether by gesture or by dragging to a wastebasket, is accompanied by clear feedback—sound and/or visualisation at the point of deletion—that material has indeed been deleted. The visualisation of a deletion operation makes the use of an “interactive undo” function easier to use as the direct effect of previous deletion operations may be readily seen.

These and other aspects of the present invention will be apparent from and elucidated with reference to the embodiments described herein.

Embodiments of the present invention will now be described, by way of examples only and with reference to the accompanying drawings, in which:

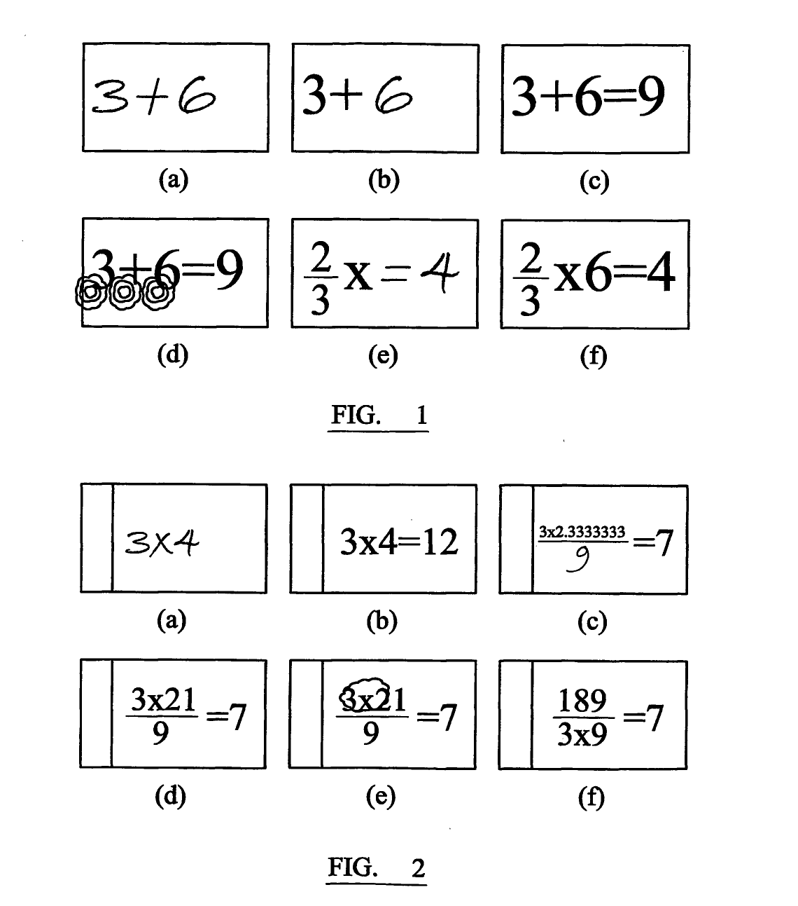

FIGS. 1a to 1f illustrate a calculator according to an exemplary embodiment of the invention when in use; and

FIGS. 2a to 2f illustrate a calculator according to an exemplary embodiment of the invention when in use.

Referring to FIGS. 1a to 1f of the drawings, in a pen-based calculator according to an exemplary embodiment of the present invention, the user is presented with a screen and a gesture based input device by means of which a sum can be “handwritten” and displayed on the screen (FIG. 1a). The visibility on the screen of the system's status is provided through two types of feedback: annotation and morphing. As the user is writing the expression, the system can process in the background and, as a symbol is recognised, the user is made aware of this recognition by visual feedback: a typeset character stretched to the stroke's hull (e.g., its bounding rectangular box) replaces the written strokes (FIG. 1b).

Morphing starts after a short time delay from when the user stops writing, and is interrupted when the user starts writing, so as to stop it from distracting the user by rearranging the expression while the user is still entering it. The morph formats the entered expression into a correctly typeset equation by moving the symbols as little as possible from the user's writing. The morph provides the continuity between the user's input and the typeset equation that allows them to continue to edit and use it. Thus, the system can be considered to be split into two modules: the first providing basic symbol recognition using, for example, a model-matching algorithm, many forms of which will be known to a person skilled in the art, and formatting the symbols into a correctly typeset equation; and the second recognising the equation using, for example, a recursive descent algorithm or other known method, calculating the answer (e.g., by constraint propagation or other equation solving means) and displaying the answer at the correct location relative to the equation (FIG. 1c). The interaction and user-interface are preferably layered on top of these two modules.

Note that standard methods of parsing are typically concerned with error reporting; in the present application, instead the concern is error correction without losing the user's input or other work. For example, rather than report the syntax error of a missing operand in the user's recognised input of 4+=5, the reaction is to insert the missing operand and to calculate its value, hence in this example 1 will inserted, to make 4+1=5.

Several different methods of editing an expression once it has been entered into the system are envisaged. For many mathematical expressions, the easiest way to edit them is to delete and then rewrite some or all of the expression (FIG. 1d). One of the principle features of a calculator according to this exemplary embodiment of the present invention is that the equation displayed on the screen is always and at all times correct, a feature hereinafter referred to as instantly declarative, as described below. In the example of FIGS. 1a to 1c, the user enters a sum and the system calculates the answer and displays it. However, by the same principle, it is possible, to write a partial sum on the left hand side and the answer on the right-hand side (FIG. 1e), or vice versa, and the system will calculate the rest of the left-hand expression and display it so that the entire expression is correct (FIG. 1f).

However, one of the principal advantages of the present invention relative to known calculators and other user interfaces is the ability to automatically effect intuitive ink modification of a displayed expression as a result of dynamic manual modification of elements thereof. Referring to FIGS. 2a to 2f of the drawings, a user first writes a simple multiplication sum which is displayed on the screen. As shown in FIG. 2a, the system is performing the character recognition while the user is still formulating the expression, and it is “catching up” in the sense that it has already rendered the ‘3’ in a typographically neat font. In one exemplary embodiment, the user input may be displayed in a first colour (say, blue) as it is being input, and then ‘dry’ to another colour (say, black) when the character recognition has been performed and a character has been rendered in a typographically neat font, so that what is currently being written cannot be confused with what is already on the screen.

As shown in FIG. 2b, the system morphs the user's input when they stop writing, described above, and combines it with a calculated output to display a nicely typeset equation. The output generated by the calculator is preferably displayed in yet another colour (say, red) or otherwise distinguished.

The equation can now be edited by the user. For example, if the output is deleted and rewritten as ‘7’, the system automatically recalculates the left-hand expression to make the complete expression correct. If, then, a division line is drawn underneath the left-hand expression and a ‘9’ entered below that (see FIG. 2c), the system once again recalculates the entire expression so that it is mathematically correct and morphs the combined typeset output and the user's input into another neatly typeset equation (see FIG. 2d).

It is also possible to select elements of an existing expression and drag the selected portion of the expression to another location in the expression. Thus, referring to FIG. 2e, it can be seen that the elements ‘3x’ above the division line have been selected and then dragged to a position below the division line (see FIG. 2f). Once again, the entire expression is morphed and the number above the division line is recalculated to maintain the mathematical accuracy of the overall expression, which is once again displayed in the form of a nicely typeset equation.

As illustrated in FIG. 2e, the calculator of this exemplary embodiment of the invention supports “drag and drop” rearrangement; the selection is freeform and can be any shape. Once the user has selected some “ink” it can be moved to any desired location; the dragging is not syntactically constrained. Although complete symbols are selected and dragged, they do not need to form syntactic units (such as well-formed subexpressions), and they need not be adjacent. (For example, the top and bottom of a fraction could be selected and moved, without moving the division sign itself; or the division sign and the denominator alone could be moved elsewere; and so on.) The selected ink is dragged to any point on the display, and the display is then re-processed, much as if the same ink had been written by the user in the destination place to start with.

Deletion is provided through a standard metaphor of the wastebasket: users can drag any selected “ink” to the wastebasket, and the expression will be recalculated without the ink the user removed. In FIGS. 2a to 2f, the wastebasket can be seen in the bottom-right corner. The wastebasket is preferably movable, so when used on, say, a 2 metre screen it can be moved conveniently closer to the equation to reduce hand movement. Other gestures can be used for deletion, such as crossing out, as previously mentioned.

Just as ink (whether syntactic or semantic) parts of the calculation can be dragged and edited, they can be stored. A dock storage interface is used herein in resembling Apple's doc k in Mac OS X. A dock keeps the storage interface physically separate from the mathematical editing. In FIGS. 2a to 2f the dock can be seen in grey at the left of the screen; there are four equations shown stored in it—although not easily readable in the Figures, the dock contains easily readable equations at full size.

Once a user has stored mathematical expressions they can retain their semantic meaning. When a user drags them out of the ‘dock,’ they behave as the value of the equation previously stored, and the user can insert the value into any expressions. For example if the equation 2+3=1+4 is dragged from the dock, a small representation of it can be dragged anywhere into the current calculation, and it behaves as a numerical value, in this case 5.

Alternatively, clicking on (an alternative gesture to dragging) an item in the dock swaps the current equation for a full-screen version of the dock item. The dock can now be edited and thus be used to store useful constants, to store formulae (e.g., conversions), or to help the user break a very complex equation into more manageable parts. The dock can be a resource on the web, like a web page, so that teachers or others can provide resources of equations or constants, including dynamic data such as temperatures, prices, currency conversion rates and other such facts. As a web page, the dock can also be shared interactively between users in different places.

A calculator according to this exemplary embodiment of the invention uses explicit operators where there could be a misunderstanding over the implicit annotation or operator, for example, it inserts an explicit multiplication between a “)” and a “(”. Rather than leave the user with their hand-written input, the calculator converts everything to a typeset, well laid-out mathematical expression, and this allows the users to know with certainty what is being computed, instead of wondering whether they have entered it correctly, or if the computer is recognising their handwriting correctly, or if there is some invisible mode or data affecting the result. In short, there is no hidden information or state, and all visible information is used. The calculator shows exactly what is being computed, thus there is no confusion for the user.

However, the calculator can have modes that expand its power and utility for different applications: for example, there can be a mode in which the required answer (which is normally displayed) is chosen to be hidden, to allow a user to enter the answer as part of a teaching or similar exercise. Other modes that have been embodied (in our prototypes) include changing x to do roots or prime factorisation (e.g., 6=2.45×2.45 or 6=3×2); changing/to do rational arithmetic; changing + to partition on whole+fractional values or powers of two (e.g., 7=4+2+1); controlling numerical or symbolic precision; and so on. Many other such modes can easily be envisaged, which make the basic design more specialised to particular applications.

Instead of forcing a user to think syntactically about the structure of how the mathematics works to edit an expression, the calculator lets a user interact more flexibly with the actual ink used. Of course, conventional calculators very severely limit what “editing” is—it is typically limited to appending characters or deleting the last number or the entire calculation. Although the two-dimensional notation of mathematics contains the necessary syntactic relations, the calculator according to this exemplary embodiment of the invention does not impose this. Instead, ink editing allows the user to edit their work naturally as a picture, in a way that is impossible with any one-dimensional (conventional) representations. This flexible ink editing of two-dimensional notation allows the user to rearrange and edit mathematics semantically or syntactically, in a way that can be very close to how the user thinks about the abstract mathematics. The principle behind the present invention means that the semantics of any expression is directly linked to the “ink.” For example, drawing a horizontal line might mean either a division sign or a subtraction, depending on what the user means. The calculator disambiguates, by allowing either interpretation, which can be changed at any time. For example, if numbers are written above or below a subtraction line, the line becomes a division symbol; and if they are both deleted, it reverts to subtraction. In these examples, the horizontal line (-) has flexibly taken on the role of either subtraction (e.g., as in −5) or division (e.g., 5/9); thus, the line itself has no fixed syntactic role: it is just ink.

For clarification, this exemplary embodiment of the invention will now be briefly compared with the prior art. Some calculators provide template-based entry of complex calculations. For example, to enter a fraction like 5/9 the user would choose n/n from a menu of structures. Then the ‘blobs’ are selected and the user enters numbers (here, 5 and 9) or further formulae. In the new calculator, the user can do any of the following:
Write 5, underline it, write 9.
Write 9, overline it, write 5.
Write a line, write 5 above, write 9 below.
Write a line, write 9 below, write 5 above.
Write 59, underline it, drag and drop the 9 to below the line and so on.

It can be seen that the approach proposed herein affords a considerable freedom for the user (and hence vastly improved ease of use), compared to conventional approaches. With templates, the user has to select the correct template first then write 5 or 9; on calculators without templates, there is only one solution, namely to do 5, then /, then 9.

The essence of an instantly declarative interface is that it cannot show the user something that is false, ever. For example an instantly declarative calculator could never show “3+4=15”. The display has to be correct without any further user action; and instantly. The benefits for the user are obvious: there is no confusion for the user, the input and output always correspond. The interface feels natural and immediately responsive to user input. More profoundly, instant declarativeness means that the interface is able to cope with partial and incomplete input and to respond fully in a timely fashion. Requiring complete input normally leads to very modal user interaction. This may be suitable in some domains (e.g., with safety related issues), but in an instantly declarative system it is, in principle, unnecessary.

The power of a declarative interface can be fully realised when combined with a two-way equivalence between the user's input actions and the system's output. This, added to the equal opportunity that treats output and input equally, creates a uniquely usable interface. Users are able to solve problems, such as “what power of 2 is 56?” (i.e., 2x=56) directly that they might have no idea of how to solve otherwise, and which would anyway be impossible without circumlocution.

This concept works smoothly with a calculator, because the output and input are the same format and can be combined in the same expression. With the present calculator, a user can replace the computer output with their own, and nothing will change. This means that if the user writes the correct answer in, then the calculator shows no extra work, and it means that if the user writes a wrong sum like “3+4=15” the calculator corrects it, in this case to 3+4+8=15 (here the ‘+8’ error correction would be visually distinguished).

The visibility of the system's status is provided through two kinds of feedback: annotation and morphing. These together provide clear feedback about exactly what is happening with the user's input and the computation being performed.

As explained above, throughout a calculation, the calculator morphs the input into a neatly typeset output equation. The morph provides continuity between the user's input and the typeset equation that allows them to continue to edit and use it.

A further feature enhances the ease of use and flexibility of the design. A conventional-looking round analogue clock with two hands ‘ticks’ when the calculator is morphing the user's input. The user can touch (click on) or drag any hand of the clock, and change the time. Say if, a user makes a mistake, the user will spin the hands of the clock back to the ‘time’ just before they made the mistake. (This is another use of equal opportunity: the user editing advances the clock time, and the user changing the time directly by manipulating the dock undoes or redoes their editing accordingly.) Another use is for a teacher who wants to see how a student got a particular result: the teacher can literally take the time back and forwards to review in an animated replay of what the student has done and how they achieved their current results. Of course, when time is run back (otherwise called ‘undo’), the user can start again with what is displayed and change the display any way they like, as described above.

Thus, what is described above is a novel calculator, for interactive whiteboards, pen-based devices and the like, which provides a better task fit than conventional approaches. The calculator provides a natural, dynamic method of entering calculations by normal handwriting and provides continual feedback showing progress and results. The user interface adjusts and copes with partial user input, morphing the user's writing to its correct position and syntax. Gestures are also used to edit and manipulate calculations.

An exemplary embodiment of the present invention in the form of a pen-based calculator is described in detail above. However, it will be appreciated that the principles of the present invention could be applied to other gesture-based, interactive user-interfaces and the present invention is not necessarily intended to be limited in this regard.

It should be noted that the above-mentioned embodiments illustrate rather than limit the invention, and that those skilled in the art will be capable of designing many alternative embodiments without departing from the scope of the invention as defined by the appended claims. In particular, variation of the operations and layout do not depart from the scope of the invention; for example, the current embodiment uses square roots using √ but other roots (e.g., cube roots) could be handled in the usual way; the current embodiment uses = as both an operator and a relation, so it can appear very flexibly more than once and anywhere in an equation (e.g., as appearing three times in 2¹⁺²⁼³=8=1+7); the current embodiment uses both / and - for division; the current embodiment handles fractions such as 1+½ with an explicit plus sign, but teachers may prefer it presented as

$$1 \frac{1}{2} ;$$

the implicit multiplication in (1+2)×(3+4) is shown, but need not be; and so on. Similarly, representing numbers in different ways, say, Arabic, Roman, unary (e.g., as counters, pictures of sheep or whatever, perhaps in lines or rectangles, etc), makes no difference to the basic operation of the invention.

In the claims, any reference signs placed in parentheses shall not be construed as limiting the claims. The word “comprising” and “comprises,” and the like, does not exclude the presence of elements or steps other than those listed in any claim or the specification as a whole. The singular reference of an element does not exclude the plural reference of such elements and vice versa. The invention may be implemented by means of hardware comprising several distinct elements, and/or by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A gesture-based user interface, comprising display means and a gesture-based input means for generating a user-defined expression comprised of characters, digits and/or symbols for display on said display means, the user interface further comprising recognition means for recognising said characters, digits and/or symbols, means for enabling a user-defined edit event in respect of a portion of said expression, an edit event comprising adding, deleting or altering one or more characters, digits or symbols, means for recognising said edit event and automatically rearranging said expression to maintain the syntax thereof depending on the nature of an edit event and the relationship between the revised set of characters, digits and/or symbols resulting from said edit event.

2. An interface according to claim 1, wherein the recognition means is arranged to re-render said characters, digits and/or symbols to a typeset format for display on said display means.

3. An interface according to claim 1 or claim 2, wherein said expression comprises a mathematical equation having one or more unknown quantities, and the interface is arranged to automatically calculate said unknown quantities.

4. An interface according to any one of claims 1 to 3, further comprising means for correcting errors, whether semantic or syntactic, in said expression without losing the remainder of the expression.

5. An interface according to claim 3, wherein said resultant unknown quantity is displayed on the display means as an integral part of the displayed equation.

6. An interface according to claim 3, wherein said resultant unknown quantity is hidden from display.

7. An interface according to any one of claims 1 to 5, arranged and configured to automatically correct one or more user-defined elements of an expression, in the event that the expression is syntactically incorrect, and display the resultant syntactically correct expression on the display means.

8. An interface according to any one of claims 1 to 6, wherein user-defined elements of an expression are displayed in a different format, texture or colour relative to elements defined or calculated by said interface.

9. An interface according to any one of claims 1 to 8, wherein a wastebasket is defined in respect of said display means for discarding at least a selected portion of said expression.

10. An interface according to claim 9, further comprising means for providing an audio and/or visual indication to confirm to a user that said at least said at least a selected portion of said expression has been discarded.

11. An interface according to any one of claims 1 to 10, wherein an edit event is performed by drag and drop means selectively applied to electronic ink defining said expression on said display means and means for reparsing of dragged content in its new position on said display means.

12. An interface according to any one of claims 3 to 5, wherein an unknown quantity or other character, digit or symbol calculated or otherwise generated by said interface is distinguished visually on said display means from said user-defined characters, digits or symbols of said expression.

13. An interface according to claim 12, wherein said unknown quantity or other character, digit or symbol calculated or otherwise generated by said interface is distinguished from said user-defined characters, digits or symbols by colour, style, font or other visual means.

14. An interface according to any one of the preceding claims, further comprising a clock means for direct control of the time, so as to provide on said display means an animated undo/redo function.

15. An interface according to any one of claims 1 to 14, comprising means for defining and dragging or otherwise moving portions of a displayed expression, either to another location within the expression, or to a location on said display means defining a wastebasket for discarding the defined portion of the expression.

16. An interface according to any one of the preceding claims, wherein said expression, or at least a portion thereof, is retrieved from a dock for storing and exchanging data, whether fixed or updatable.

17. An interface according to claim 16, wherein said dock is held locally to or remotely from said interface.

18. An interface according to claim 16 or claim 17, wherein said data is retrievable from said dock by means of one or more gestures performed by a user in respect of said display means.

19. An interface substantially as herein described with reference to the accompanying drawings.
